(19) United States
(12) Patent Application Publication
(10) Pub. No.: US 2014/0130576 A1
(43) Pub. Date: May 15, 2014

(54) SYSTEM AND METHOD FOR MONITORING CONDITION OF AT LEAST ONE NOZZLE

(71) Applicants: Stefan Blendinger, Fürth (DE); Robert Fleck, Adelsdorf (DE); Gerold Franke, Nuremberg (DE); Lilla Grossmann, Erlangen (DE); Werner Hartmann, Weisendorf (DE)

(72) Inventors: Stefan Blendinger, Fürth (DE); Robert Fleck, Adelsdorf (DE); Gerold Franke, Nuremberg (DE); Lilla Grossmann, Erlangen (DE); Werner Hartmann, Weisendorf (DE)

(73) Assignee: SIEMENS AKTIENGESELLSCHAFT, München (DE)

(21) Appl. No.: 14/126,758

(22) PCT Filed: May 29, 2012
(86) PCT No.: PCT/EP2012/060009

§ 371 Date: Dec. 16, 2013

(30) Foreign Application Priority Data
Jun. 15, 2011 (EP) 11169978.1

(51) Int. Cl. G01M 99/00

(52) U.S. Cl. CPC G01M 99/00
USPC 73/37

(57) ABSTRACT

A two- or three-phase mixture is sprayed using at least one nozzle which has associated therewith at least one structure-borne sound sensor for detecting a sound power level signal in the region of the nozzle and also at least one gas and/or liquid meter for detecting a volumetric flow of gas and/or liquid directed through the nozzle.

### CROSS REFERENCE TO RELATED APPLICATIONS

This application is the U.S. national stage of International Application No. PCT/EP2012/060009, filed May 29, 2012 and claims the benefit thereof. The International Application claims the benefit of European Application No. 11169978 filed on Jun. 15, 2011, both applications are incorporated by reference herein in their entirety.

### BACKGROUND

Described below is a system and method for monitoring a condition of at least one nozzle for spraying a two-phase or three-phase mixture.

Nozzles for spraying or introducing substance mixtures of substances of different aggregate states into process chambers or spaces are sufficiently well known in a wide range of industrial branches. Nozzles are used for example to spray two-substance mixtures of gas and solid particles or gas and liquid. This is known for example in the field of metal production, where carbon particles, lime particles, etc. are blown into a smelting furnace with the aid of a gas. In this and various other sectors liquid fuels, such as heavy oil for example, are sprayed with gases containing oxygen and then combusted, to operate furnaces or perform other heating processes, etc. The spraying of two-phase mixtures in the form of suspensions of solid particles and liquid is also already known from the fields of waste water engineering, swimming pool engineering, flotation technology for the processing of raw materials and the like.

The spraying of three-phase mixtures of gas, solid particles and liquid is also used for example in flotation.

Flotation is a physical separation method for separating fine-grain solid mixtures, for example of ore and gangue, in an aqueous slurry or suspension with the aid of gas bubbles based on the differing surface wettability values of the particles contained in the suspension. It is used to process natural resources and when treating e.g., mineral materials with a low to medium useful component or, as the case may be, reusable material content, for example in the form of non-ferrous metals, iron, rare earth metals and/or precious metals and non-metallic natural resources.

WO 2006/069995 A1 describes a pneumatic flotation cell with a housing that encloses a flotation chamber, with at least one nozzle for feeding suspension into the flotation chamber, referred to here as ejectors, also with at least one feed arrangement for feeding gas into the flotation chamber, referred to as ventilation facilities or aerators when air is used, and a collector for a foam product formed during flotation.

During the course of pneumatic flotation a suspension of water and fine-grain solids containing reagents is generally introduced into a flotation chamber by way of at least one nozzle. The reagents are to cause in particular the valuable particles to be separated or, as the case may be, reusable material particles to be configured in a hydrophobic manner in the suspension. Xanthates are usually used as reagents, in particular to hydrophobize sulphidic ore particles in a selective manner. Gas, in particular air, is fed to the at least one nozzle at the same time as the suspension, coming into contact with the hydrophobic particles in the suspension. A three-phase mixture is thus sprayed into the flotation chamber by way of the nozzle or, as the case may be, ejector. The hydrophobic particles adhere to forming gas bubbles, so that the bubble structures float up and form the foam product on the surface of the suspension. The foam product is carried out into a collector and generally further concentrated.

A nozzle for spraying a two-phase or three-phase mixture is generally subject to a high level of mechanical and abrasive stress. When the two-phase or three-phase mixture flows through the nozzle at high speed or where there are cavitation-type processes, the material from which the nozzle is formed is eroded and the geometric dimensions of the nozzle change. The erosion of the material in the region of the inner wall of the nozzle can be relatively regular here or local differences can occur.

The changed geometric dimensions of the nozzle result in a change in the mixing and breaking down of the phases of the two-phase or three-phase mixture and as a result generally to a deterioration in the region of the subsequent processes. In the case of a nozzle or, as the case may be, an ejector for spraying a three-phase mixture of solid particles, liquid and gas into a flotation chamber the deterioration in the mixing and breaking down of the three phases for example generally results in a reduced performance of the flotation cell.

Such a nozzle is therefore a part that is subject to wear, which has to be regularly checked and if necessary overhauled or replaced with a newly manufactured nozzle. Depending on the area of use of the nozzle, such an inspection or maintenance should be performed at time intervals of several times a day up to once a year. For example in the case of a nozzle or, as the case may be, an ejector for spraying a three-phase mixture of solid particles, liquid and gas into a flotation chamber, an inspection is generally performed once or twice a year. Production must be stopped for the purpose and every part of the flotation cell that is subject to wear, including the nozzles or, as the case may be, ejectors, must be examined and assessed individually. The inspection is labor-intensive and time-intensive. All the parts subject to wear that are identified as damaged and have to be replaced have to be in stock, to ensure rapid replacement and not to extend the stoppage time of the flotation cell unnecessarily.

### SUMMARY

Described below are a system and method that have been appropriately improved for monitoring a condition of at least one nozzle for spraying a two-phase or three-phase mixture.

The system monitors a condition of at least one nozzle for spraying a two-phase or three-phase mixture with the nozzle assigned at least one structure-borne sound sensor for detecting a sound power level signal in the region of the nozzle and also has at least one gas and/or liquid meter for detecting a volumetric flow of gas and/or liquid carried by way of the nozzle.

The system allows permanent monitoring of the condition of wear of the nozzle, without having to interrupt the supply of two-phase or three-phase mixture to the nozzle or having to stop the technical installation in which the nozzle is operated. It has been demonstrated in fact that the measurable sound power level at a newly manufactured nozzle is above the sound power level of a nozzle which is already subject to geometric changes due to wear. It has also been established that the consumption of gas and/or liquid to form the two-phase or three-phase mixture rises as the wear on the nozzle increases. It is therefore possible to conclude the existing wear on the nozzle from the sound power level signal detected at the nozzle and the measured volumetric flow of gas and/or liquid and to forecast how long the nozzle can operate before maintenance will be required. This simplifies the setting of a servicing appointment by which time maintenance will actually be required and allows precise planning for the stocking and re-ordering of parts subject to wear.

The method for monitoring a condition of at least one nozzle for spraying a two-phase or three-phase mixture has the nozzle assigned at least one structure-borne sound sensor for detecting a sound power level signal in the region of the nozzle and also at least one gas and/or liquid meter for detecting the volumetric flow of gas and/or liquid supplied by way of the nozzle. A maintenance appointment is set for the at least one nozzle based on an evaluation of the sound power level signals and the volumetric flows.

As it is possible to conclude the currently existing condition of wear of the nozzle from the sound power level signal detected at the nozzle and the measured volumetric flow, it is also possible in a simple manner to forecast how long the nozzle can operate before maintenance will be required. While it has normally been necessary to select a fixed rota for maintenance appointments and maintenance has then been performed regardless of whether the condition of wear of the nozzle actually required it, the sequence of maintenance appointments can now be set as a function of the actual condition of wear of the respective nozzle. Therefore where there are a number of nozzles present, the maintenance appointment can be adjusted based on the condition of wear of the monitored nozzle that has already worn to the greatest degree. This maximizes the time interval between two service appointments, avoids nozzle failure and unnecessary stoppages and minimizes storage costs for parts subject to wear.

The structure-borne sound sensor can be disposed on the outside of the nozzle and is therefore itself protected against wear and can be used almost without limit.

A further indication of nozzle wear is also provided by the pressure that can be measured upstream of the nozzle in the two-phase or three-phase mixture. As soon as a noticeable drop in pressure can be observed here compared with an initial value for the pressure that can be measured at a new nozzle, wear is generally also present at the nozzle. It is therefore advantageous if the system also has at least one pressure sensor disposed upstream of the nozzle for detecting the pressure in the two-phase or three-phase mixture. This allows further verification of observations relating to the condition of wear of the nozzle, which have been recorded by the at least one structure-borne sound sensor and the at least one gas or liquid meter.

The nozzle may be disposed in the system in such a manner that the two-phase or three-phase mixture is sprayed into a chamber. In an embodiment, the chamber can be a flotation chamber of a flotation cell. Alternatively the chamber can however also be a combustion chamber, in particular in a smelting plant or a heating unit. However the system is of course also suitable for nozzles that spray the two-phase or three-phase mixture into the environment, for example into the atmosphere or even into an ocean.

In particular the at least one nozzle of the system is however an ejector for spraying a three-phase mixture of solid particles, liquid and at least one gas into a chamber, for example a flotation chamber. Such nozzles are subject to a particularly high level of wear and unnecessary or premature maintenance is associated with enormous cost and unnecessary production loss.

In one embodiment of the system or, as the case may be, method at least one computation unit is also present, which is or will be connected for data purposes to the at least one structure-borne sound sensor and the at least one gas and/or liquid meter, also the at least one pressure sensor where applicable. The computation unit allows automatic detection and storage of the data and its automatic evaluation.

The at least one computation unit may be set up to store and correlate over time for a time period t the sound power level signals detected by the at least one structure-borne sound sensor and the volumetric flow of gas and/or liquid detected by the at least one gas and/or liquid meter, also a pressure upstream of the nozzle detected by the at least one pressure sensor where applicable. This allows the profile of the sound power level signal and the volumetric flow to be tracked.

The at least one computation unit may include a display unit, which is set up to output the correlated signals visually for the maintenance personnel.

The computation unit also may be set up to calculate a mean volumetric flow of gas and/or liquid if required from the volumetric flow of gas and/or liquid and to calculate a mean sound power level signal from the sound power level signals and, if the resulting value is above a first threshold value for the volumetric flow or mean volumetric flow and/or below a second threshold value for the mean sound power level signal, to generate a warning signal, which indicates that maintenance should be performed or the nozzle should be replaced. In the process the warning signal indicates the forecast maintenance appointment. The prewarning time for maintenance or, as the case may be, the time interval between the occurrence of the warning signal and the actual maintenance appointment here can be adjusted based on the required order and delivery times for the required part subject to wear.

The first threshold value here is selected in particular in such a manner that it is 20% above a volumetric flow measured at the newly manufactured nozzle or a mean volumetric flow of gas and/or liquid.

The second threshold value may be selected in such a manner that it is 50% below the mean sound power level signal measured at a newly manufactured nozzle.

The computation unit also may be set up optionally to calculate a mean pressure upstream of the nozzle from the detected pressure and to generate a further warning signal if the resulting value is below a further threshold value for the pressure or the mean pressure. The outputting of both the warning signal and the further warning signal should be understood as confirmation of existing wear.

The system and method are suitable for monitoring the condition of all nozzles for spraying a two-phase or three-phase mixture. Provision is made in particular for an application for monitoring ejectors for spraying two-phase or three-phase mixtures, for example suspensions or suspensions containing gas, into flotation chambers or nozzles for spraying two-phase mixtures of gas and solid particles or gas and liquids into a combustion chamber. However the system and method can also be used profitably for other fields of application, for example in waste water engineering, paper production or the chemical industry.

### BRIEF DESCRIPTION OF THE DRAWINGS

These and other aspects and advantages will become more apparent and more readily appreciated from the following description of the exemplary embodiments, taken in conjunction with the accompanying drawings of which:

FIGS. 1 to 4 describe different embodiments of the system and method by way of example. Thus

FIG. 1 is a block diagram of a system having a computation unit;

FIG. 2 is a graph useful in evaluation of the signals supplied by the system;

FIG. 3 is a block diagram of shows a system with a nozzle for a flotation cell;

FIG. 4 is a block diagram of a system with a nozzle for an electric arc furnace.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

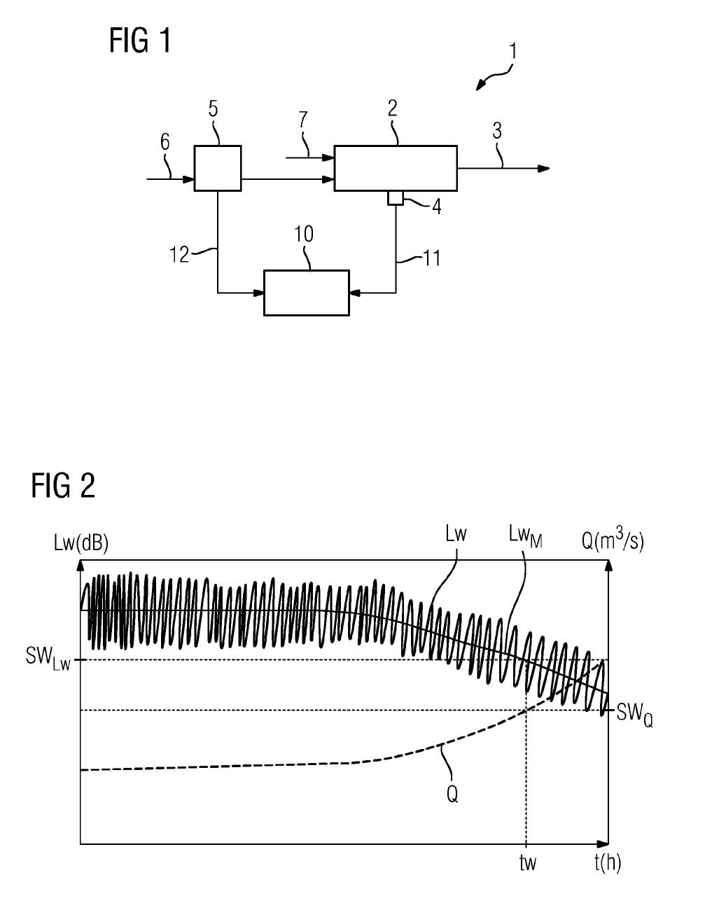

FIG. 1 shows a system 1 for monitoring a condition of a nozzle 2, in this instance for spraying a three-phase mixture 3 formed from a suspension 7 of water and ore mineral particles and a gas 6, in this instance in the form of air. The nozzle 2 is assigned a structure-borne sound sensor 4 for detecting a sound power level signal in the region of the nozzle 2 and also at least one gas meter 5 for detecting the volumetric flow of gas 6 passed by way of the nozzle 2. The system 1 here also has a computation unit 10, which is connected by way of data transmission lines 11, 12 to the structure-borne sound sensor 4 and the gas meter 5. Instead of the data transmission lines 11, 12 a cableless data connection, for example by way of radio, can also be present between the computation unit 10 and the structure-borne sound sensor 4 and the gas meter 5.

The sound power level signals Lw (see FIG. 2) detected by the structure-borne sound sensor 4 and the signal for the volumetric flow Q of gas 6 detected by the gas meter 5 are transmitted to the computation unit 10 and evaluated. Instead of the computation unit 10 the signals for the sound power level Lw and the volumetric flow Q can alternatively be picked up manually at the structure-borne sound sensor 4 and gas meter 5 and the results can be evaluated manually in a corresponding manner.

FIG. 2 shows an example of an evaluation of the signals supplied by the system 1. The sound power level Lw detected by the structure-borne sound sensor 4 in dB and the volumetric flow Q of gas detected by a gas meter 5 in m³/s are shown on the Y axis. The operating time t of the monitored nozzle 2 is shown on the X axis—depending on the expected wear behavior—in hours, days, weeks or even years. Here the operating time t is shown in hours by way of example. A maintenance appointment tw for the nozzle 2 is set based on an evaluation of the sound power level signals Lw and the volumetric flow Q.

In some instances the computation unit 10 is set up, as required if the signal fluctuates significantly, to calculate a mean volumetric flow of gas and/or liquid from the volumetric flow of gas and/or liquid. The computation unit 10 is also set up to calculate a mean sound power level signal Lw_{M} from the sound power level signals Lw and, if the resulting value is above a first threshold value SW_{Q} for the volumetric flow Q or mean volumetric flow and/or below a second threshold value SW_{LW} for the mean sound power level signal L_{wM}, to generate a warning signal, which indicates that maintenance should be performed or the nozzle 2 should be replaced at the appointment tw.

The system 1 can also have a pressure sensor (not shown in detail here), which determines a pressure upstream of the nozzle and is optionally connected for data purposes to the computation unit 10. The measured pressure or, as the case may be, an extent of a drop in pressure compared with the measured pressure at a newly manufactured nozzle can be evaluated as an additional indication that wear has occurred on the nozzle.

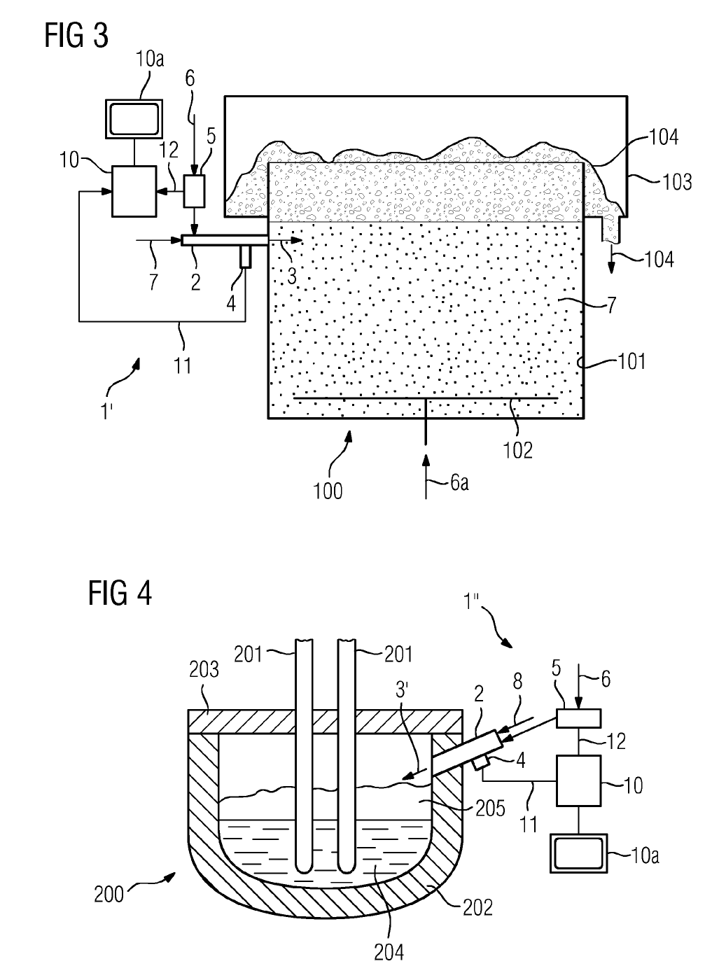

FIG. 3 shows a system 1′ with a nozzle 2, which is operated in the manner of an ejector of a flotation cell 100. Identical reference characters to those in FIG. 1 signify identical elements. The system 1′ has a computation unit 10, which includes a display unit 10a. This is set up to output the correlated signals for the volumetric flow Q and the sound power level Lw, Lw_{M} visually, for example in a graphic display according to FIG. 2.

The flotation cell 100 includes a flotation chamber 101 (shown in cross section), into which a three-phase mixture 3 formed from a suspension 7 containing solid particles of ore mineral and water and a gas 6 in the form of air is introduced by the nozzle 2.

Suspension 7, to which further gas 6a in the form of air has been added by a schematically illustrated gas feed arrangement 102, is already present in the flotation chamber 101. In the upper region of the flotation chamber 101 a foam product 104 with gas bubbles and particles of reusable material adhering thereto from the ore mineral forms on the surface of the suspension 7, being transported away by way of a foam collection channel 103 also illustrated in cross section. The system 1′ can be used to determine an optimum maintenance appointment for the nozzle 2 and the maintenance can be performed in a scheduled manner at this appointment.

FIG. 4 shows a system 1″ with a nozzle 2 for an electric arc furnace 200. Identical reference characters to those in FIG. 1 signify identical elements. The system 1″ has a computation unit 10, which includes a display unit 10a. This is set up to output the correlated signals for the volumetric flow Q and the sound power level Lw, Lw_{M} visually, for example in a graphic display according to FIG. 2.

The schematically illustrated electric arc furnace 200 includes a furnace vessel 202 (shown in cross section) with a furnace cover 203, into which a two-phase mixture 3′ of solid particles 8, for example carbon particles, and a gas 6 in the form of air is introduced by the nozzle 2. Alternatively the nozzle 2 can operate as a burner, by way of which a two-substance mixture of heavy oil and oxygen can be formed, sprayed and ignited.

Present in the furnace vessel 202 is a molten metal bath 204, on which a layer of slag 205 has formed. The furnace space above the slag forms a combustion space of the metallurgical plant. Electrodes 201 made of graphite are passed through the furnace cover 203 to generate an arc.

The system 1″ allows an optimum maintenance appointment to be determined for the nozzle 2 and the maintenance to be performed in a scheduled manner at this appointment.

The above exemplary embodiments obviously do not cover all the embodiments of the invention or all the possible applications. It is also possible to monitor simultaneously a number of nozzles, in which identical or different two-phase or three-phase mixtures are sprayed. Various other fields of application, for example in waste water engineering, are also possible. Also in the case of two-substance mixtures in the form of suspensions a liquid meter can be present or, in the case of two-substance mixtures of gas and liquid, a gas and liquid meter can be present.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-19. (canceled)

20. A system for monitoring a condition of at least one nozzle for spraying a two-phase or three-phase mixture, comprising:
at least one structure-borne sound sensor, assigned to the at least one nozzle, detecting a sound power level signal in a region around the nozzle; and
at least one gas and/or liquid meter detecting a volumetric flow of gas and/or liquid emitted from the at least one nozzle.

21. The system as claimed in claim 20, further comprising at least one pressure sensor, disposed upstream of the at least one nozzle, detecting pressure in the two-phase or three-phase mixture.

22. The system as claimed in claim 21, wherein the at least one nozzle is disposed to spray into a chamber.

23. The system as claimed in claim 22, wherein the chamber is a flotation chamber of a flotation cell.

24. The system as claimed in claim 23, wherein the at least one nozzle is an ejector for spraying a three-phase mixture of solid particles, liquid and at least one gas into the chamber.

25. The system as claimed in claim 22, wherein the chamber is a combustion chamber in one of a smelting plant and a heating unit.

26. The system as claimed in claim 21, further comprising at least one computation unit connected to receive data from the at least one structure-borne sound sensor, the at least one gas and/or liquid meter and the at least one pressure sensor.

27. The system as claimed in claim 26, wherein the at least one computation unit stores and correlates over time for a time period the sound power level signal detected by the at least one structure-borne sound sensor, the volumetric flow of gas and/or liquid detected by the at least one gas and/or liquid meter and the pressure upstream of the at least one nozzle detected by the at least one pressure sensor.

28. The system as claimed in claim 27, wherein the at least one computation unit has a display unit outputting correlated signals visually.

29. The system as claimed in claim 26, wherein the computation unit calculates a mean volumetric flow of gas and/or liquid from the volumetric flow of gas and/or liquid and a mean sound power level signal from the sound power level signal stored at multiple times and, when the mean volumetric flow is above a first threshold or the mean sound power level signal is below a second threshold, generates a warning signal indicating that maintenance should be performed or the at least one nozzle should be replaced.

30. The system as claimed in claim 29, wherein the computation unit calculates a mean pressure upstream of the at least one nozzle from the pressure detected at multiple times and generates a further warning signal if the mean pressure is below a third threshold.

31. A method for monitoring a condition of at least one nozzle for spraying a two-phase or three-phase mixture, comprising:
assigning the at least one nozzle at least one structure-borne sound sensor for detecting a sound power level signal in a region around the at least one nozzle;
detecting, by at least one gas and/or liquid meter, volumetric flow of gas and/or liquid emitted by the at least one nozzle; and
setting a maintenance appointment for the at least one nozzle based on an evaluation of the sound power level signal and the volumetric flow.

32. The method as claimed in claim 31, further comprising detecting pressure in the two-phase or three-phase mixture by at least one pressure sensor disposed upstream of the at least one nozzle.

33. The method as claimed in claim 32, further comprising:
receiving data by at least one computation unit from the at least one structure-borne sound sensor, the at least one gas and/or liquid meter and the at least one pressure sensor; and
storing and correlating over time the sound power level signal detected by the at least one structure-borne sound sensor, the volumetric flow detected by the at least one gas and/or liquid meter and the pressure detected by the at least one pressure sensor.

34. The method as claimed in claim 33, further comprising outputting the correlated signals visually by way of a display unit of the at least one computation unit.

35. The method as claimed in claim 33, further comprising:
calculating a mean volumetric flow from the volumetric flow stored at multiple times by the at least one computation unit, and
generating the warning signal which indicates the maintenance appointment when the mean volumetric flow is above a first threshold.

36. The method as claimed in claim 35, wherein the first threshold is 20% above an initial volumetric flow measured using the newly manufactured nozzle.

37. The method as claimed in claim 35, further comprising:
calculating a mean sound power level signal from the sound power level signal stored at multiple times by the at least one computation unit, and
generating a warning signal which indicates the maintenance appointment when the mean sound power level signal is below a second threshold.

38. The method as claimed in claim 37, wherein the second threshold is 50% below the mean sound power level signal measured using a newly manufactured nozzle.

39. The method as claimed in claim 38, further comprising:
calculating a mean pressure upstream of the at least one nozzle from the pressure stored at multiple times by the at least one computation unit; and
generating a further warning signal when the mean pressure is below a third threshold.
